(19) United States
(12) Patent Application Publication
(10) Pub. No.: US 2024/0172745 A1
(43) Pub. Date: May 30, 2024

(54) METHOD AND COMPOSITIONS FOR THE CONTROL OF SOME PESTS

(71) Applicant: FUTURE-TENSE TECHNOL DEVEL & ENTREPRENEURSHIP LTD, Caesarea (IL)

(72) Inventor: Yoram Tsivion, Caesarea (IL)

(73) Assignee: FUTURE-TENSE TECHNOL DEVEL & ENTREPRENEURSHIP LTD, Caesarea (IL)

(21) Appl. No.: 18/431,369

(22) Filed: Feb. 2, 2024

Related U.S. Application Data
(63) Continuation of application No. PCT/IB21/57201, filed on Aug. 5, 2021.

(51) Int. Cl. A01N 25/02; A01N 59/16; A01N 59/20; A01P 1/00; A01P 7/04

(52) U.S. Cl. CPC A01N 25/02; A01N 59/16; A01N 59/20; A01P 1/00; A01P 7/04

(57) ABSTRACT

A formulation for extending the activity of micronutrient based pesticides over a period of time. The formulation includes an aqueous solution of metal ions some of which may be chelated, and at least one water soluble polymer.

### CROSS-REFERENCE TO RELATED APPLICATIONS

The present application claims priority to International Patent Application No. PCT/IB2021/057201, filed 5 Aug. 2021, entitled “Method and compositions for the control of pests.” The aforementioned application is hereby incorporated herein by reference.

### TECHNICAL FIELD

The present invention generally relates to formulations of chemical agents for use in agriculture.

### BACKGROUND ART

Fertilizers which include micronutrients are known for their effect as controlling agents in the combat against agricultural pests such as: bacteria (Phytopathologia Mediterranea 2018; DOI:10.14601 Phytopathol_Mediterr-21985), fungi (IL patent 97676) and certain insects (International patent application WO2020110110).

The remarkable activity of Dentamet® formulations (distributed in Italy by Diagro s.r.l. and Diachem S.p.A have prompted the quest for a product with a sustained activity that would support prolonged periods between application in the field.

Typically, in micronutrient fertilizers, some or all of the heavy metal ions included (iron, zinc, manganese and copper) are chelated with some form of ligand even though the purpose of such chelation may be unspecified or obscure.

### DISCLOSURE OF THE INVENTION

In accordance with embodiments of the present invention a micronutrient based pesticidal preparation applied to plant surfaces such as leaves and stems, can be made to confer longer lasting anti pesticidal effect by adding a water soluble polymer and mixing to homogenise the mixture. If a precipitate is formed, it can be filtered out.

International patent application WO 2020/110110, incorporated herein by reference, discloses formulations of micro-nutrients which demonstrated a detrimental effect towards populations of several species of Pentatomid insect pests (also known as stink bugs), with impetus on Halyomorpha Halys, a new invasive species reaching Europe and US from east Asia. Such formulations were used as components of the novel formulations developed as described further below. It should be mentioned at this stage that as discussed in the patent application mentioned above, the effect of the micronutrient application causes the disablement of the pentamoid pest indirectly rather than directly, namely by damaging their symbiotic bacteria.

Pesticidal compositions in accordance with the present invention were prepared each including a component of anionic polymers polyacrylic acid (PAA) and/or poly methacrylic acid (PMAA).

### EXAMPLES OF FORMULATIONS IN ACCORDANCE WITH THE PRESENT INVENTION

### Example I—Experimental Composition 1

### Table 1 Shows the Contents of Composition 1 (in Weight Units)

| | quantity | Molecular |
|---|---|---|
| component | in grams | weight |
| water | 285.17 | |
| Sulfuric acid | 13.13 | |
| Lactic acid | 71.28 | |
| PMAA, 30% in water, | 35.37 | 9,500 |
| neutralized by Na+ | | |
| ZnSO4•7H2O | 97.03 | |
| CuSO4•5H2O | 47.92 | |
| PAA, 35% in water, | 50.10 | 15,000 |
| neutralized by Na+ | | |

### Example II—Experimental Composition 2

### Table 2 Shows the Contents of Composition 2 (in Weight Units)

| | quantity | Molecular |
|---|---|---|
| component | in grams | Weight |
| water | 514 | |
| Sulfuric acid | 18 | |
| citric acid | 100 | |
| monohydrate | | |
| PAA, 45% in | 200 | 1,200 |
| water, neutralized | | |
| by Na+ | | |
| ZnSO4•7H2O | 178 | |
| CuSO4•5H2O | 80 | |

### Field Trials

Such were performed and analysed by the team of Professor Alberto Alma in DISAFA (Dipartimento di Scienze Agrarie, Forestali e Alimentari, Largo P. Braccini, 2-10095 Grugliasco (TO) Italy.

### Grape Vine Trials

In order to test the effect of experimental compositions prepared in accordance with the present invention, sections of branches of grapevines were encaged in a mesh secluding these sections of the treated branch from internalization of external stink bugs and vice versa, yet allowing exchange of gasses with the ambient atmosphere.

Treatments (using formulation of example II above) were applied at the concentration of 5 mL/L on isolated grapevine shoots in the experimental vineyard at the DISAFA. Mated females were caged within the treated shoots one hour after treatments, and left until oviposition. Three time-range classes from treatment to oviposition were counted: 1-2 days, 3-5 days, 6-7 days. The preliminary results confirmed previous evidences obtained a year earlier, as ˜90% I instar mortality was detected in the encaged shoots, with no significant differences among time range classes, suggesting high persistence of the treatments, which supports the possibility to reduce the number of treatments in the field without a efficiency decrease, by using this formulation.

### Hazelnuts Trials

The effect of Dentamet® (4 application cycles, 10 days apart, at the rate of 0.4 L/hL) on the production losses was compared with the experimental product composition 2 (administered at 3 applications cycles, 15 days apart, at the rate of 0.4 L/hL), and with an untreated control. Significant differences were detected both in the percentage of healthy nuts (Dentamet® and composition 2, both higher than the control) and in the percentage of damaged nuts (Dentamet® and composition 2, lower than the control, with no significant differences between the two products. These results confirm the effectiveness of treatments with micronutrient fertilizers as a field strategy for hazelnut, and further support the possibility to employ product composition 2 with the same effectiveness while reducing the number of application cycles.

Comparative Concentrations of Heavy Metals in the Composition Applied to the Hazelnut Plants

TABLE 3
Compares the heavy metal content (in w/w % of
Dentamet ® vs composition 2)

| | Composition 2, metal | Dentamet ®, metal |
|---|---|---|
| Heavy metal | concentration | concentration |
| Zn | 3.71 | 4.0 |
| Cu | 1.87 | 2.0 |

It should be noted that in the hazelnut trials, although composition 2 contains less heavy metal than Dentamet®, and was administered in the field applying 1 cycle less, results are similar to the Dentamet® application.

1. A formulation for extending the activity of micronutrient based pesticides over a period of time, said formulation comprising:
an aqueous solution of metal ions, and
at least one water soluble polymer.

2. A formulation for extending the activity of micronutrient based pesticides over a period of time as in claim 1, wherein at least some of said metal ions are chelated.

3. A formulation for extending the activity of micronutrient based pesticides over a period of time as in claim 1, wherein said polymer is PAA.

4. A formulation for extending the activity of micronutrient based pesticides over a period of time as in claim 1, wherein said polymer is PMAA.

5. A formulation for extending the activity of micronutrient based pesticides over a period of time as in claim 1, wherein said pests are pantotemid insects.

6. A formulation for extending the activity of micronutrient based pesticides over a period of time, as in claim 1, wherein said pests are bacteria.
